(19) United States
(12) Patent Application Publication
(10) Pub. No.: US 2016/0344311 A1
(43) Pub. Date: Nov. 24, 2016

(54) APPLICATION DEVICE AND MOTOR DRIVING CIRCUIT

(71) Applicant: Johnson Electric S.A., Murten (CH)

(72) Inventors: Chi Ping SUN, Hong Kong (CN); Shing Hin YEUNG, Hong Kong (CN); Fei XIN, Shen Zhen (CN); Xiu Wen YANG, Shen Zhen (CN); Shu Juan HUANG, Shen Zhen (CN); Yun Long JIANG, Shen Zhen (CN); Yue LI, Hong Kong (CN); Bao Ting LIU, Shen Zhen (CN); En Hui WANG, Shen Zhen (CN); Li Sheng LIU, Shen Zhen (CN); Yan Yun CUI, Shen Zhen (CN)

(21) Appl. No.: 15/230,955

(22) Filed: Aug. 8, 2016

Related U.S. Application Data
(63) Continuation-in-part of application No. 14/822,353, filed on Aug. 10, 2015.
Application No. 14/822,353 is a continuation of application No. PCT/CN2015/086422, filed on Aug. 7, 2015.

(30) Foreign Application Priority Data
Aug. 8, 2014 (CN) 201410390592.2
Aug. 15, 2014 (CN) 201410404474.2
Jul. 8, 2016 (CN) 201610539478.0

(51) Int. Cl. H02P 1/46; H02P 6/20; H02K 11/215; H02K 21/14; H02K 1/27; H02K 11/049

(52) U.S. Cl. CPC H02P 1/46; H02K 1/2706; H02K 11/049; H02K 11/215; H02K 21/14; H02P 6/20

(57) ABSTRACT

A motor driving circuit and an application device are provided. In an embodiment, an AC switch is connected between first and second nodes. A rotational direction control circuit connects to the first and second nodes and is configured to selectively connect the first node to first terminal of an AC power supply through motor winding and connect the second node to second terminal of the AC power supply, or connect the first node to second terminal of AC power supply and connect the second node to first terminal of the AC power supply through the motor winding. A detecting circuit is configured to detect magnetic pole position of the rotor. A switch control circuit is configured to control the AC switch to be turned on or be turned off in a predetermined way based on magnetic pole position signal and potential difference between the first and second nodes.

### CROSS REFERENCE TO RELATED APPLICATIONS

This non-provisional patent application is a continuation-in-part of U.S. patent application Ser. No. 14/822,353, which claims priority to Chinese Patent Application No. 201410390592.2, filed on Aug. 8, 2014 and to Chinese Patent Application No. 201410404474.2, filed on Aug. 15, 2014. In addition, this non-provisional patent application claims priority under the Paris Convention to PCT Patent Application No. PCT/CN2015/086422, filed with the Chinese Patent Office on Aug. 7, 2015, to Chinese Patent Application No. CN201610539478.0, filed with the Chinese Patent Office on Jul. 8, 2016, both of which are incorporated herein by reference in their entirety.

### FIELD

The present disclosure relates to the technical field of motor control, and in particular to a motor driving circuit and an application device.

### BACKGROUND

During starting of a synchronous motor, the stator produces an alternating magnetic field causing the permanent magnetic rotor to be oscillated. The amplitude of the oscillation of the rotor increases until the rotor begins to rotate, and finally the rotor is accelerated to rotate in synchronism with the alternating magnetic field of the stator. To ensure the starting of a conventional synchronous motor, a starting point of the motor is set to be low, which results in that the motor cannot operate at a relatively high working point, thus the efficiency is low. In another aspect, the rotor cannot be ensured to rotate in a same direction every time since a stop or stationary position of the permanent magnetic rotor is not fixed. Accordingly, in applications such as a fan and water pump, the impeller driven by the rotor has straight radial vanes, which results in a low operational efficiency of the fan and water pump.

FIG. 1 illustrates a conventional drive circuit for a synchronous motor, which allows a rotor to rotate in a same predetermined direction in every time it starts. In the circuit, a stator winding 1 of the motor is connected in series with a TRIAC between two terminals M and N of an AC power source VM, and an AC power source VM is converted by a conversion circuit DC into a direct current voltage and the direct current is supplied to a position sensor H. A magnetic pole position of a rotor in the motor is detected by the position sensor H, and an output signal Vh of the position sensor H is connected to a switch control circuit PC to control the bidirectional thyristor T.

FIG. 2 illustrates a waveform of the drive circuit. It can be seen from FIG. 2 that, in the drive circuit, no matter the bidirectional thyristor T is switched on or off, the AC power source supplies power for the conversion circuit DC so that the conversion circuit DC constantly outputs and supplies power for the position sensor H (referring to a signal VH in FIG. 2). In a low-power application, in a case that the AC power source is commercial electricity of about 200V, the electric energy consumed by two resistors R2 and R3 in the conversion circuit DC is more than the electric energy consumed by the motor.

The present disclosure aims to provide a motor driving circuit which is able to control forward or reverse rotation of a motor.

### SUMMARY

A motor driving circuit is provided according to an embodiment of the present disclosure. The motor driving circuit is configured to drive a rotor of a motor to rotate relative to a stator of the motor. The motor driving circuit includes:

a controllable bidirectional alternating current switch connected between a first node and a second node;

a rotational direction control circuit connected to the first node and the second node and configured to selectively connect the first node to a first terminal of an external alternating current power supply through a winding of the motor and connect the second node to a second terminal of the external alternating current power supply, or to connect the first node to the second terminal of the external alternating current power supply and connect the second node to the first terminal of the external alternating current power supply through the winding of the motor;

a detecting circuit, configured to detect a magnetic pole position of the rotor and output a magnetic pole position signal from an output terminal; and

a switch control circuit, configured to control the controllable bidirectional alternating current switch to be turned on or be turned off in a predetermined way, based on the magnetic pole position signal outputted by the detecting circuit and a difference between a potential of the first node and a potential of the second node.

In a preferred embodiment, the switch control circuit is configured to turn on the controllable bidirectional alternating current switch in a case that the potential of the first node is higher than the potential of the second node and the detecting circuit outputs a first magnetic pole position signal, or in a case that the potential of the first node is lower than the potential of the second node and the detecting circuit outputs a second magnetic pole position signal and configured to turn off the controllable bidirectional alternating current switch in a case that the potential of the first node is higher than the potential of the second node and the detecting circuit outputs the second magnetic pole position signal, or in a case that the potential of the first node is lower than the potential of the second node and the detecting circuit outputs the first magnetic pole position signal.

In a preferred embodiment, the rotor rotates in a first direction when the rotational direction control circuit connects the first node to the first terminal of the external alternating current power supply through the winding of the motor and connects the second node to the second terminal of the external alternating current power supply; and the rotor rotates reversely in a second direction when the rotational direction control circuit connects the first node to the second terminal of the external alternating current power supply and connects the second node to the first terminal of the external alternating current power supply through the winding of the motor.

In a preferred embodiment, the rotational direction control circuit includes a first switch and a second switch, each of the first switch and the second switch includes a first terminal, a second terminal and a third terminal, the first terminal of the first switch is connected to the first node, the second terminal of the first switch is connected to the first terminal of the external alternating current power supply through the winding of the motor, and the third terminal of the first switch is connected to the second terminal of the external alternating current power supply, the first terminal of the second switch is connected to the second node, the second terminal of the second switch is connected to the second terminal of the first switch, and the third terminal of the second switch is connected to the second terminal of the external alternating current power supply, in a case that the motor rotates in the first direction, the first terminal of the first switch is connected to the second terminal of the first switch, and the first terminal of the second switch is connected to the third terminal of the second switch; and in a case that the motor rotates reversely in the second direction, the first terminal of the first switch is connected to the third terminal of the first switch, and the first terminal of the second switch is connected to the second terminal of the second switch.

In a preferred embodiment, the motor driving circuit further includes a rectifier configured to at least supply a direct current voltage to the detecting circuit.

In a preferred embodiment, the rectifier is connected to the first node through a voltage dropper; or the rectifier is connected to the first terminal of the external alternating current power supply through a voltage dropper and the winding of the motor.

In a preferred embodiment, at least two or all of the rectifier, the detecting circuit, the switch control circuit and the rotational direction control circuit are integrated into an integrated circuit.

In a preferred embodiment, at least two or all of the detecting circuit, the switch control circuit and the rotational direction control circuit are integrated into an integrated circuit.

A motor driving circuit is provided according to an embodiment of the present disclosure. The motor driving circuit is configured to drive a rotor of a motor to rotate relative to a stator of the motor. The motor driving circuit includes:

a controllable bidirectional alternating current switch connected to a winding of the motor in series between a first node and a second node;

a rotational direction control circuit connected to the first node and the second node and configured to selectively connect the first node to a first terminal of an external alternating current power supply and connect the second node to a second terminal of the external alternating current power supply, or connect the first node to the second terminal of the external alternating current power supply and connect the second node to the first terminal of the external alternating current power supply;

a detecting circuit, configured to detect a magnetic pole position of the rotor and output a magnetic pole position signal from an output terminal; and

a switch control circuit configured to control the controllable bidirectional alternating current switch to be turned on or be turned off in a predetermined way, based on the magnetic pole position signal outputted by the detecting circuit, a potential of the first node and a potential of the second node.

In a preferred embodiment, the motor driving circuit further includes a rectifier configured to at least supply a direct current voltage to the detecting circuit, and the rectifier is connected to the first node through a voltage dropper, or the rectifier is connected to the first terminal of the external alternating current power supply through a voltage dropper and the winding of the motor.

In a preferred embodiment, the switch control circuit is configured to turn on the controllable bidirectional alternating current switch in a case that the potential of the first node is higher than the potential of the second node and the detecting circuit outputs a first magnetic pole position signal or in a case that the potential of the first node is lower than the potential of the second node and the detecting circuit outputs a second magnetic pole position signal and configured to turn off the controllable bidirectional alternating current switch in a case that the potential of the first node is higher than the potential of the second node and the detecting circuit outputs the second magnetic pole position signal or in a case that the potential of the first node is lower than the potential of the second node and the detecting circuit outputs the first magnetic pole position signal.

In a preferred embodiment, the rotor rotates in a first direction in a case that the rotational direction control circuit connects the first node to the first terminal of the external alternating current power supply through the winding of the motor and connects the second node to the second terminal of the external alternating current power supply; and the rotor rotates reversely in a second direction in a case that the rotational direction control circuit connects the first node to the second terminal of the external alternating current power supply and connects the second node to the first terminal of the external alternating current power supply through the winding of the motor.

In a preferred embodiment, the rotational direction control circuit includes a first switch and a second switch, each of the first switch and the second switch includes a first terminal, a second terminal and a third terminal; the first terminal of the first switch is connected to the first node, the second terminal of the first switch is connected to the first terminal of the external alternating current power supply through the winding of the motor, and the third terminal of the first switch is connected to the second terminal of the external alternating current power supply, the first terminal of the second switch is connected to the second node, the second terminal of the second switch is connected to the second terminal of the first switch, and the third terminal of the second switch is connected to the second terminal of the external alternating current power supply, in a case that the motor rotates in the first direction, the first terminal of the first switch is connected to the second terminal of the first switch, and the first terminal of the second switch is connected to the third terminal of the second switch, and in a case that the rotor rotates reversely in the second direction, the first terminal of the first switch is connected to the third terminal of the first switch, and the first terminal of the second switch is connected to the second terminal of the second switch.

An application device having a motor which includes a stator, a rotor and the motor driving circuit according to any of the above descriptions

In a preferred embodiment, the motor includes a single-phase permanent-magnetic alternating current motor.

In a preferred embodiment, the motor includes a single-phase permanent-magnetic synchronous motor or a single-phase permanent-magnetic brushless direct current (BLDC) motor.

The motor driving circuit according to the embodiments of the present disclosure controls, based on the magnetic pole position of the rotor, a direction of a current flowing through the winding of the stator of the motor via the rotational direction control circuit, so as to control the forward or reverse rotation of the motor. The motor driving circuit has a simple structure and a high versatility.

### BRIEF DESCRIPTION OF THE DRAWINGS

The drawings to be used in the description of embodiments of the disclosure or the conventional technology are described briefly as follows, so that technical solutions according to the embodiments of the present disclosure or according to the conventional technology become clearer. It is apparent that the drawings in the following description only illustrate some embodiments of the present disclosure. For those skilled in the art, other drawings may be obtained according to these drawings without any creative work.

FIG. 1 illustrates a prior art drive circuit for a synchronous motor, according to an embodiment of the present disclosure;

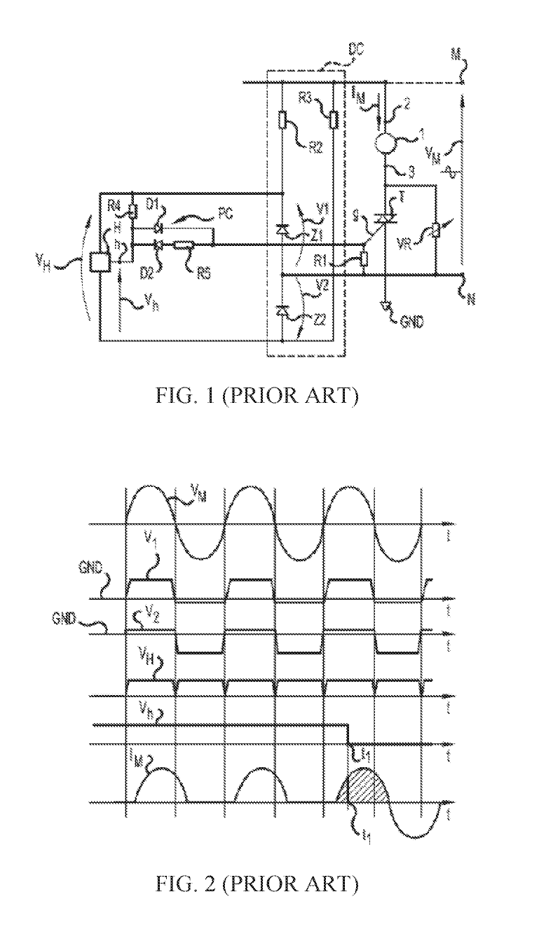

FIG. 2 illustrates a waveform of the drive circuit shown in FIG. 1;

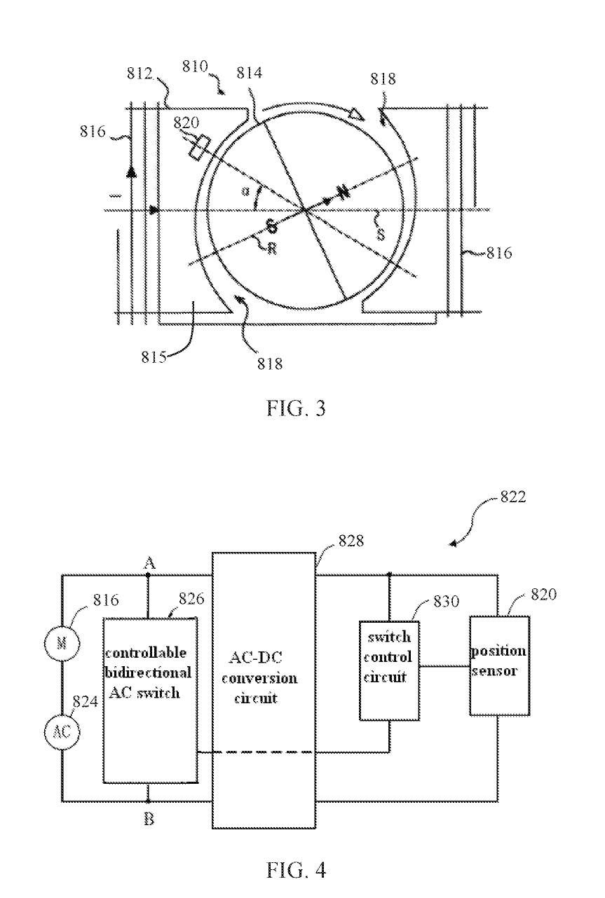

FIG. 3 illustrates a diagrammatic representation of a synchronous motor, according to an embodiment of the present disclosure;

FIG. 4 illustrates a block diagram of a drive circuit for a synchronous motor, according to an embodiment of the present disclosure;

FIG. 5 illustrates a drive circuit for a synchronous motor, according to an embodiment of the present disclosure;

FIG. 6 illustrates a waveform of the drive circuit shown in FIG. 5;

FIGS. 7 to 10 illustrate different embodiments of a drive circuit of a synchronous motor, according to an embodiment of the present disclosure;

FIG. 11 shows a motor according to an embodiment of the present disclosure;

FIG. 12 is a schematic circuit diagram of a motor according to a first embodiment of the present disclosure;

FIGS. 13 and 14 are circuit diagrams illustrating that the motor driving circuit shown in FIG. 12 controls the motor to rotate forward;

FIGS. 15 and 16 are circuit diagrams illustrating that the motor driving circuit shown in FIG. 12 controls the motor to rotate reversely;

FIG. 17 is a schematic circuit diagram of a motor according to a second embodiment of the present disclosure;

FIG. 18 is a schematic circuit diagram of a motor according to a third embodiment of the present disclosure;

FIG. 19 is a circuit diagram illustrating that the motor driving circuit shown in FIG. 18 controls the motor to rotate forward;

FIG. 20 is a circuit diagrams illustrating that the motor driving circuit shown in FIG. 18 controls the motor to rotate reversely; and

FIG. 21 is a schematic circuit diagram of a motor according to a fourth embodiment of the present disclosure.

### DETAILED DESCRIPTION OF EMBODIMENTS

The technical solution is described clearly and completely hereinafter in conjunction with the drawings according to the embodiments of the present disclosure. Apparently, the described embodiments are only a part rather than all of the embodiments of the present disclosure. All other embodiments obtained by those skilled in the art based on the embodiments of the present disclosure without any creative effort fall within the scope of protection of the present disclosure. It can be understood that the drawings are only for reference and illustration, and are not to limit the present disclosure. The connection shown in the drawings is for clear description and is not to limit the connection modes.

It should be noted that, if an element is described as “connected to” another element, the element may be connected to the other element directly or with an intermediate element therebetween. Any technical or scientific term in the present disclosure has the meaning same as what is normally understood by those skilled in the art, unless there are other definitions. The terms in the description are only for depicting specific embodiments, and are not to limit the present disclosure.

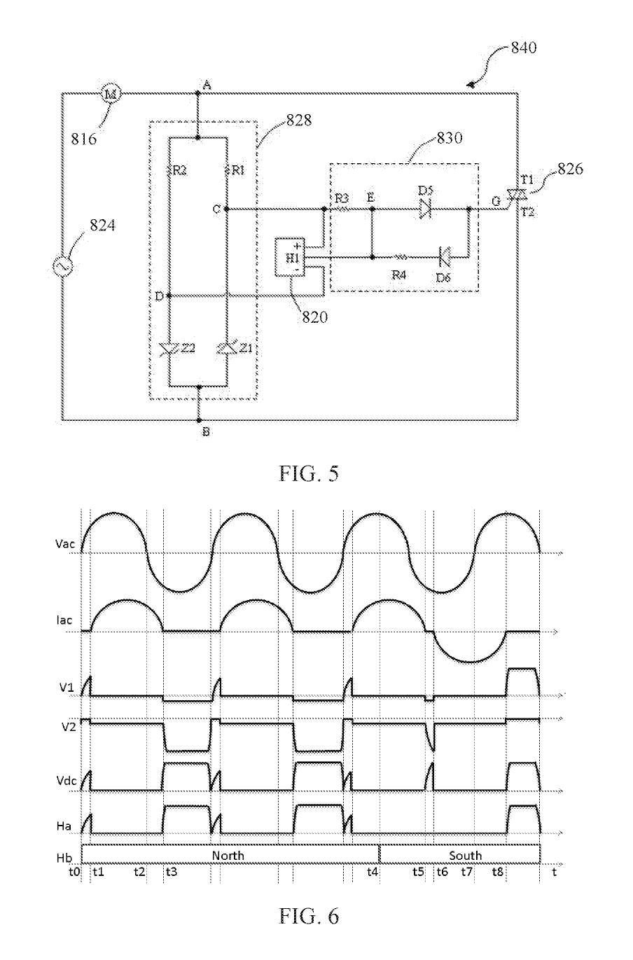

FIG. 3 schematically shows a synchronous motor according to an embodiment of the present invention. The synchronous motor 810 includes a stator 812 and a permanent magnet rotor 814 rotatably disposed between magnetic poles of the stator 812, and the stator 812 includes a stator core 815 and a stator winding 816 wound on the stator core 815. The rotor 814 includes at least one permanent magnet forming at least one pair of permanent magnetic poles with opposite polarities, and the rotor 814 operates at a constant rotational speed of 60 f/p rpm during a steady state phase in a case that the stator winding 816 is connected to an AC power supply, where f is a frequency of the AC power supply and p is the number of pole pairs of the rotor.

Non-uniform gap 818 is formed between the magnetic poles of the stator 812 and the permanent magnetic poles of the rotor 814 so that a polar axis R of the rotor 814 has an angular offset a relative to a central axis S of the stator 812 in a case that the rotor is at rest. The rotor 814 may be configured to have a fixed starting direction (a clockwise direction in this embodiment as shown by the arrow in FIG. 3) every time the stator winding 816 is energized. The stator and the rotor each have two magnetic poles as shown in FIG. 3. It can be understood that, in other embodiments, the stator and the rotor may also have more magnetic poles, such as 4 or 6 magnetic poles.

A position sensor 820 for detecting the angular position of the rotor is disposed on the stator 812 or at a position near the rotor inside the stator, and the position sensor 820 has an angular offset relative to the central axis S of the stator. Preferably, this angular offset is also a, as in this embodiment. Preferably, the position sensor 820 is a Hall effect sensor.

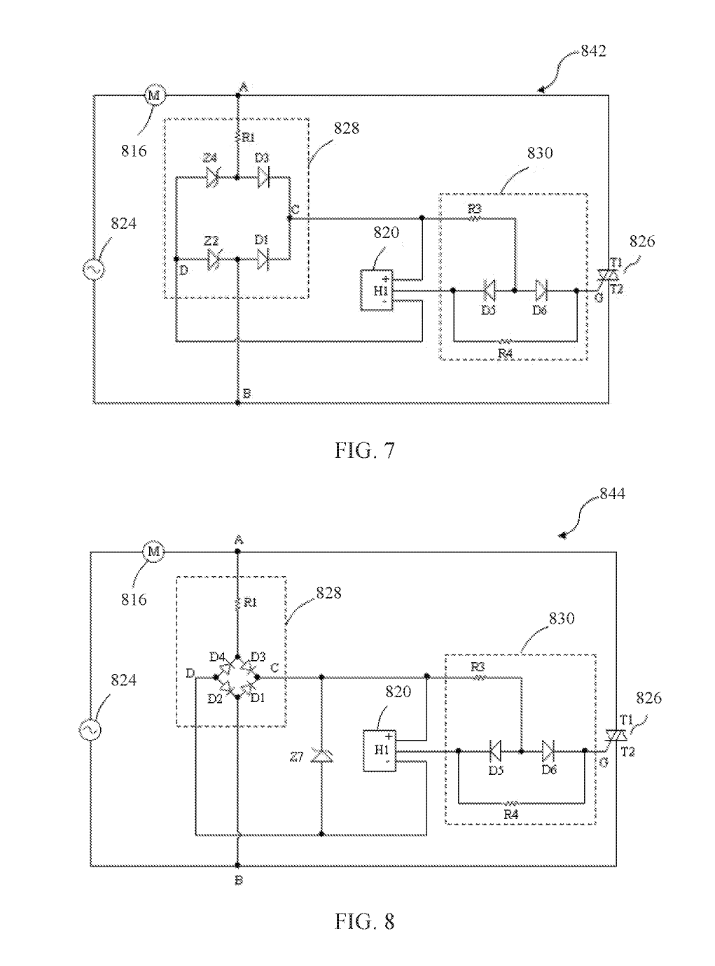

FIG. 4 shows a block diagram of a drive circuit for a synchronous motor according to an embodiment of the present invention. In the drive circuit 822, the stator winding 816 and the AC power supply 824 are connected in series between two nodes A and B.

Preferably, the AC power supply 824 may be a commercial AC power supply with a fixed frequency, such as 50 Hz or 60 Hz, and a supply voltage may be, for example, 110V, 220V or 230V. A controllable bidirectional AC switch 826 is connected between the two nodes A and B, in parallel with the stator winding 816 and the AC power supply 824. Preferably, the controllable bidirectional AC switch 826 is a TRIAC, of which two anodes are connected to the two nodes A and B respectively. It can be understood that, the controllable bidirectional AC switch 826 alternatively may be two silicon control rectifiers reversely connected in parallel, and control circuits may be correspondingly configured to control the two silicon control rectifiers in a preset way. An AC-DC conversion circuit 828 is also connected between the two nodes A and B. An AC voltage between the two nodes A and B is converted by the AC-DC conversion circuit 828 into a low voltage DC. The position sensor 820 may be powered by the low voltage DC output by the AC-DC conversion circuit 828, for detecting the magnetic pole position of the permanent magnet rotor 814 of the synchronous motor 810 and outputting a corresponding signal. A switch control circuit 830 is connected to the AC-DC conversion circuit 828, the position sensor 820 and the controllable bidirectional AC switch 826, and is configured to control the controllable bidirectional AC switch 826 to be switched between a switch-on state and a switch-off state in a predetermined way, based on the magnetic pole position of the permanent magnet rotor which is detected by the position sensor and polarity information of the AC power supply 824 which may be obtained from the AC-DC conversion circuit 828, such that the stator winding 816 urges the rotor 814 to rotate only in the above-mentioned fixed starting direction during a starting phase of the motor. According to this embodiment of the present invention, in a case that the controllable bidirectional AC switch 826 is switched on, the two nodes A and B are shorted, the AC-DC conversion circuit 828 does not consume electric energy since there is no current flowing through the AC-DC conversion circuit 828, hence, the utilization efficiency of electric energy can be improved significantly.

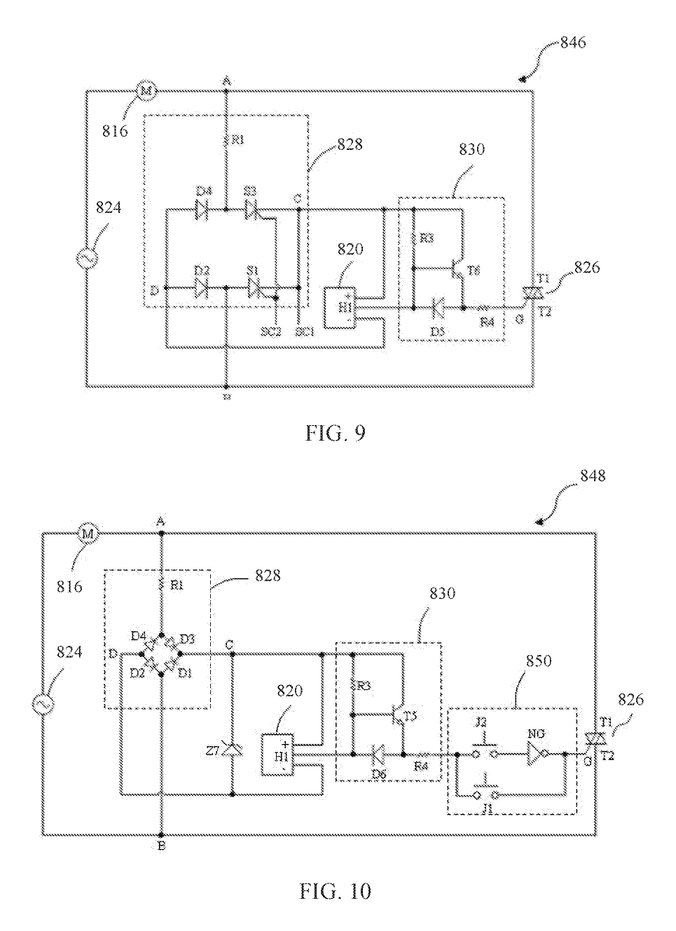

FIG. 5 shows a circuit diagram of a drive circuit 840 for a synchronous motor according to a first embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC (preferably, low voltage ranges from 3V to 18V). The AC-DC conversion circuit 828 includes a first zener diode Z1 and a second zener diode Z2 which are reversely connected in parallel between the two nodes A and B via a first resistor R1 and a second resistor R2 respectively. A high voltage output terminal C of the AC-DC conversion circuit 828 is formed at a connection point of the first resistor R1 and a cathode of the first zener diode Z1, and a low voltage output terminal D of the AC-DC conversion circuit 828 is formed at a connection point of the second resistor R2 and an anode of the second zener diode Z2. The voltage output terminal C is connected to a positive power supply terminal of the position sensor 820, and the voltage output terminal D is connected to a negative power supply terminal of the position sensor 820. Three terminals of the switch control circuit 830 are connected to the high voltage output terminal C of the AC-DC conversion circuit 828, an output terminal H1 of the position sensor 820 and a control electrode G of the TRIAC 826 respectively. The switch control circuit 830 includes a third resistor R3, a fifth diode D5, and a fourth resistor R4 and a sixth diode D6 connected in series between the output terminal HI of the position sensor 820 and the control electrode G of the controllable bidirectional AC switch 826. An anode of the sixth diode D6 is connected to the control electrode G of the controllable bidirectional AC switch 826. One terminal of the third resistor R3 is connected to the high voltage output terminal C of the AC-DC conversion circuit 828, and the other terminal of the third resistor R3 is connected to an anode of the fifth diode D5. A cathode of the fifth diode D5 is connected to the control electrode G of the controllable bidirectional AC switch 826.

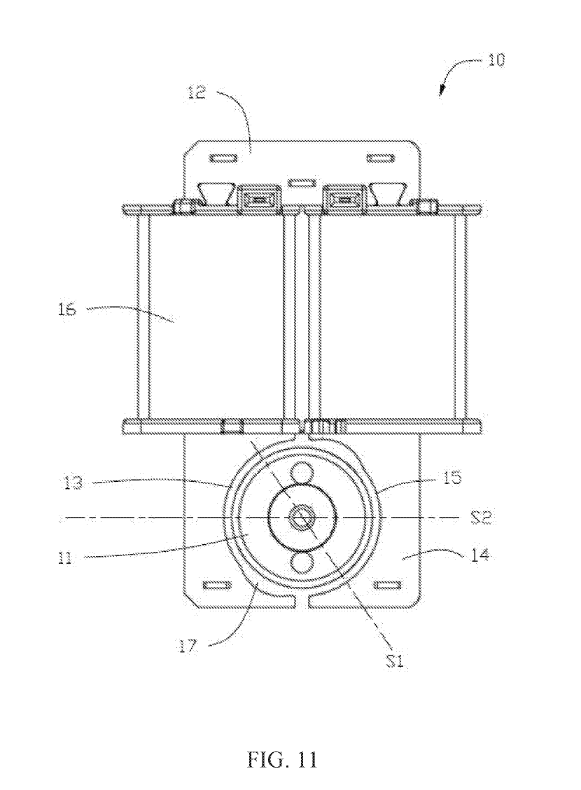

In conjunction with FIG. 6, an operational principle of the drive circuit 840 is described. In FIG. 6, Vac indicates a waveform of voltage of the AC power supply 824, and Iac indicates a waveform of current flowing through the stator winding 816. Due to the inductive character of the stator winding 816, the waveform of current Iac lags behind the waveform of voltage Vac. V1 indicates a waveform of voltage between two terminals of the first zener diode Z1, V2 indicates a waveform of voltage between two terminals of the second zener diode Z2, Vdc indicates a waveform of voltage between two output terminals C and D of the AC-DC conversion circuit 828, Ha indicates a waveform of a signal output by the output terminal H1 of the position sensor 820, and Hb indicates a rotor magnetic field detected by the position sensor 820. In this embodiment, in a case that the position sensor 820 is powered normally, the output terminal HI outputs a logic high level in a case that the detected rotor magnetic field is North, or the output terminal H1 outputs a logic low level in a case that the detected rotor magnetic field is South.

In a case that the rotor magnetic field Hb detected by the position sensor 820 is North, in a first positive half cycle of the AC power supply, the supply voltage is gradually increased from a time instant t0 to a time instant t1, the output terminal H1 of the position sensor 820 outputs a high level, and a current flows through the resistor R1, the resistor R3, the diode D5 and the control electrode G and the second anode T2 of the TRIAC 826 sequentially. The TRIAC 826 is switched on in a case that a drive current flowing through the control electrode G and the second anode T2 is greater than a gate triggering current Ig. Once the TRIAC 826 is switched on, the two nodes A and B are shorted, a current flowing through the stator winding 816 in the motor is gradually increased until a large forward current flows through the stator winding 816 to drive the rotor 814 to rotate clockwise as shown in FIG. 3. Since the two nodes A and B are shorted, there is no current flowing through the AC-DC conversion circuit 28 from the time instant t1 to a time instant t2. Hence, the resistors R1 and R2 do not consume electric energy, and the output of the position sensor 820 is stopped due to no power is supplied. Since the current flowing through two anodes T1 and T2 of the TRIAC 826 is large enough (which is greater than a holding current Ihold), the TRIAC 826 is kept to be switched on in a case that there is no drive current flowing through the control electrode G and the second anode T2. In a negative half cycle of the AC power supply, after a time instant t3, a current flowing through T1 and T2 is less than the holding current Ihold, the TRIAC 826 is switched off, a current begins to flow through the AC-DC conversion circuit 828, and the output terminal HI of the position sensor 820 outputs a high level again. Since a potential at the point C is lower than a potential at the point E, there is no drive current flowing through the control electrode G and the second anode T2 of the TRIAC 826, and the TRIAC 826 is kept to be switched off. Since the resistance of the resistors R1 and R2 in the AC-DC conversion circuit 828 are far greater than the resistance of the stator winding 816 in the motor, a current currently flowing through the stator winding 816 is far less than the current flowing through the stator winding 816 from the time instant t1 to the time instant t2 and generates very small driving force for the rotor 814. Hence, the rotor 814 continues to rotate clockwise due to inertia. In a second positive half cycle of the AC power supply, similar to the first positive half cycle, a current flows through the resistor R1, the resistor R3, the diode D5, and the control electrode G and the second anode T2 of the TRIAC 826 sequentially. The TRIAC 826 is switched on again, and the current flowing through the stator winding 816 continues to drive the rotor 814 to rotate clockwise. Similarly, the resistors R1 and R2 do not consume electric energy since the two nodes A and B are shorted. In the next negative half cycle of the power supply, the current flowing through the two anodes T1 and T2 of the TRIAC 826 is less than the holding current Ihold, the TRIAC 826 is switched off again, and the rotor continues to rotate clockwise due to the effect of inertia.

At a time instant t4, the rotor magnetic field Hb detected by the position sensor 820 changes to be South from North, the AC power supply is still in the positive half cycle and the TRIAC 826 is switched on, the two nodes A and B are shorted, and there is no current flowing through the AC-DC conversion circuit 828. After the AC power supply enters the negative half cycle, the current flowing through the two anodes T1 and T2 of the TRIAC 826 is gradually decreased, and the TRIAC 826 is switched off at a time instant t5. Then the current flows through the second anode T2 and the control electrode G of the TRIAC 826, the diode D6, the resistor R4, the position sensor 820, the resistor R2 and the stator winding 816 sequentially. As the drive current is gradually increased, the TRIAC 826 is switched on again at a time instant t6, the two nodes A and B are shorted again, the resistors R1 and R2 do not consume electric energy, and the output of the position sensor 820 is stopped due to no power is supplied. There is a larger reverse current flowing through the stator winding 816, and the rotor 814 continues to be driven clockwise since the rotor magnetic field is South. From the time instant t5 to the time instant t6, the first zener diode Z1 and the second zener diode Z2 are switched on, hence, there is a voltage output between the two output terminals C and D of the AC-DC conversion circuit 828. At a time instant t7, the AC power supply enters the positive half cycle again, the TRIAC 826 is switched off when the current flowing through the TRIAC 826 crosses zero, and then a voltage of the control circuit is gradually increased. As the voltage is gradually increased, a current begins to flow through the AC-DC conversion circuit 828, the output terminal H1 of the position sensor 820 outputs a low level, there is no drive current flowing through the control electrode G and the second anode T2 of the TRIAC 826, hence, the TRIAC 826 is switched off. Since the current flowing through the stator winding 816 is very small, nearly no driving force is generated for the rotor 814. At a time instant t8, the power supply is in the positive half cycle, the position sensor outputs a low level, the TRIAC 826 is kept to be switched off after the current crosses zero, and the rotor continues to rotate clockwise due to inertia. According to an embodiment of the present invention, the rotor may be accelerated to be synchronized with the stator after rotating only one circle after the stator winding is energized.

In the embodiment of the present invention, by taking advantage of a feature of a TRIAC that the TRIAC is kept to be switched on although there is no drive current flowing though the TRIAC once the TRIAC is switched on, it is avoided that a resistor in the AC-DC conversion circuit still consumes electric energy after the TRIAC is switched on, hence, the utilization efficiency of electric energy can be improved significantly.

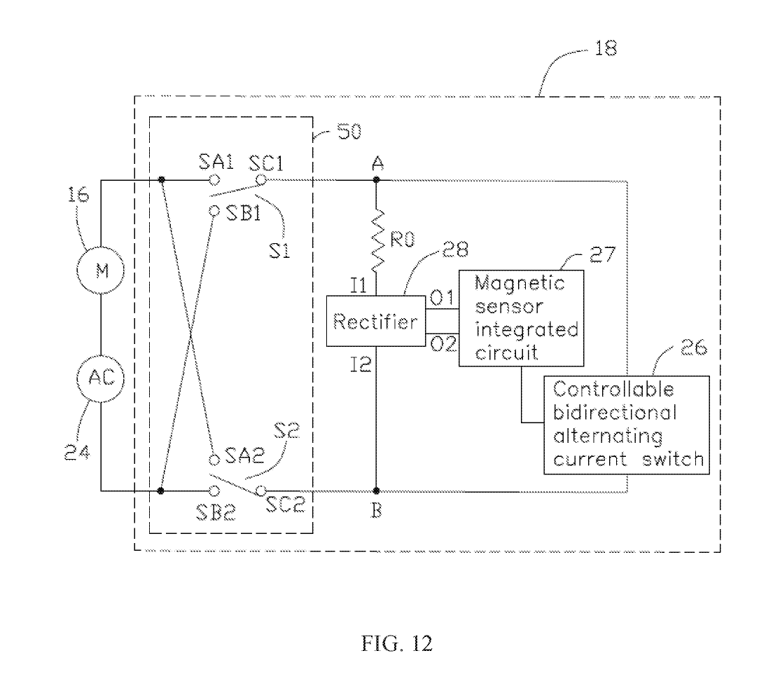

FIG. 7 shows a circuit diagram of a drive circuit 842 for a synchronous motor according to an embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes a first diode D1 and a third diode D3 reversely connected in series, and the other of the two rectifier branches includes a second zener diode Z2 and a fourth zener diode Z4 reversely connected in series, the high voltage output terminal C of the AC-DC conversion circuit 828 is formed at a connection point of a cathode of the first diode D1 and a cathode of the third diode D3, and the low voltage output terminal D of the AC-DC conversion circuit 828 is formed at a connection point of an anode of the second zener diode Z2 and an anode of the fourth zener diode Z4. The output terminal C is connected to a positive power supply terminal of the position sensor 820, and the output terminal D is connected to a negative power supply terminal of the position sensor 820. The switch control circuit 30 includes a third resistor R3, a fourth resistor R4, and a fifth diode D5 and a sixth diode D6 reversely connected in series between the output terminal H1 of the position sensor 820 and the control electrode G of the controllable bidirectional AC switch 826. A cathode of the fifth diode D5 is connected to the output terminal H1 of the position sensor, and a cathode of the sixth diode D6 is connected to the control electrode G of the controllable bidirectional AC switch. One terminal of the third resistor R3 is connected to the high voltage output terminal C of the AC-DC conversion circuit, and the other terminal of the third resistor R3 is connected to a connection point of an anode of the fifth diode D5 and an anode of the sixth diode D6. Two terminals of the fourth resistor R4 are connected to a cathode of the fifth diode D5 and a cathode of the sixth diode D6 respectively.

FIG. 8 shows a circuit diagram of a drive circuit 844 for a synchronous motor according to a further embodiment of the present invention. The drive circuit 844 is similar to the drive circuit 842 in the previous embodiment and, the drive circuit 844 differs from the drive circuit 842 in that, the zener diodes Z2 and Z4 in the drive circuit 842 are replaced by general diodes D2 and D4 in the rectifier of the drive circuit 844. In addition, a zener diode Z7 is connected between the two output terminals C and D of the AC-DC conversion circuit 828 in the drive circuit 844.

FIG. 9 shows a circuit diagram of a drive circuit 846 for a synchronous motor according to further embodiment of the present invention. The stator winding 816 of the synchronous motor is connected in series with the AC power supply 824 between the two nodes A and B. A first anode Ti of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes two silicon control rectifiers S1 and S3 reversely connected in series, and the other of the two rectifier branches includes a second diode D2 and a fourth diode D4 reversely connected in series. The high voltage output terminal C of the AC-DC conversion circuit 828 is formed at a connection point of a cathode of the silicon control rectifier S1 and a cathode of the silicon control rectifier S3, and the low voltage output terminal D of the AC-DC conversion circuit 828 is formed at a connection point of an anode of the second diode D2 and an anode of the fourth diode D4. The output terminal C is connected to a positive power supply terminal of the position sensor 820, and the output terminal D is connected to a negative power supply terminal of the position sensor 820. The switch control circuit 830 includes a third resistor R3, an NPN transistor T6, and a fourth resistor R4 and a fifth diode D5 connected in series between the output terminal H1 of the position sensor 820 and the control electrode G of the controllable bidirectional AC switch 826. A cathode of the fifth diode D5 is connected to the output terminal H1 of the position sensor. One terminal of the third resistor R3 is connected to the high voltage output terminal C of the AC-DC conversion circuit, and the other terminal of the third resistor R3 is connected to the output terminal H1 of the position sensor. A base of the NPN transistor T6 is connected to the output terminal H1 of the position sensor, an emitter of the NPN transistor T6 is connected to an anode of the fifth diode D5, and a collector of the NPN transistor T6 is connected to the high voltage output terminal C of the AC-DC conversion circuit.

In this embodiment, a reference voltage may be input to the cathodes of the two silicon control rectifiers S1 and S3 via a terminal SC1, and a control signal may be input to control terminals of S1 and S3 via a terminal SC2. The rectifiers S1 and S3 are switched on in a case that the control signal input from the terminal SC2 is a high level, or are switched off in a case that the control signal input from the terminal SC2 is a low level. Based on the configuration, the rectifiers S1 and S3 may be switched between a switch-on state and a switch-off state in a preset way by inputting the high level from the terminal SC2 in a case that the drive circuit operates normally. The rectifiers S1 and S3 are switched off by changing the control signal input from the terminal SC2 from the high level to the low level in a case that the drive circuit fails. In this case, the TRIAC 826, the conversion circuit 828 and the position sensor 820 are switched off, to ensure the whole circuit to be in a zero-power state.

FIG. 10 shows a circuit diagram of a drive circuit 848 for a synchronous motor according to another embodiment of the present invention. The drive circuit 848 is similar to the drive circuit 846 in the previous embodiment and, the drive circuit 848 differs from the drive circuit 846 in that, the silicon control diodes S1 and S3 in the drive circuit 846 are replaced by general diodes D1 and D3 in the rectifier of the drive circuit 848, and a zener diode Z7 is connected between the two terminals C and D of the AC-DC conversion circuit 828. In addition, in the drive circuit 848 according to the embodiment, a preset steering circuit 850 is disposed between the switch control circuit 30 and the TRIAC 826. The preset steering circuit 850 includes a first jumper switch J1, a second jumper J2 switch and an inverter NG connected in series with the second jumper switch J2. Similar to the drive circuit 846, in this embodiment, the switch control circuit 830 includes the resistor R3, the resistor R4, the NPN transistor T5 and the diode D6. One terminal of the resistor R4 is connected to a connection point of an emitter of the transistor T5 and an anode of the diode D6, and the other terminal of the resistor R4 is connected to one terminal of the first jumper switch J1, and the other terminal of the first jumper switch J1 is connected to the control electrode G of the TRIAC 826, and the second jumper switch J2 and the inverter NG connected in series are connected across two terminals of the first jumper switch J1. In this embodiment, when the first jumper switch J1 is switched on and the second jumper switch J2 is switched off, similar to the above embodiments, the rotor 814 still starts clockwise; when the second jumper switch J2 is switched on and the first jumper switch J1 is switched off, the rotor 814 starts counterclockwise. In this case, a starting direction of the rotor in the motor may be selected by selecting one of the two jumper switches to be switched on and the other to be switched off. Therefore, in a case that a driving motor is needed to be supplied for different applications having opposite rotational directions, it is just needed to select one of the two jumper switches J1 and J2 to be switched on and the other to be switched off, and no other changes need to be made to the drive circuit, hence, the drive circuit according to this embodiment has good versatility.

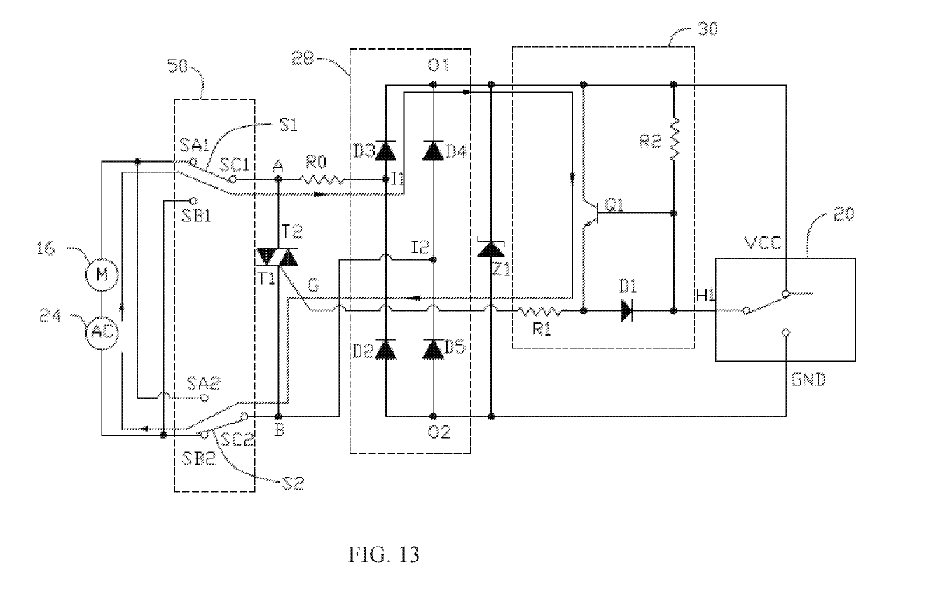

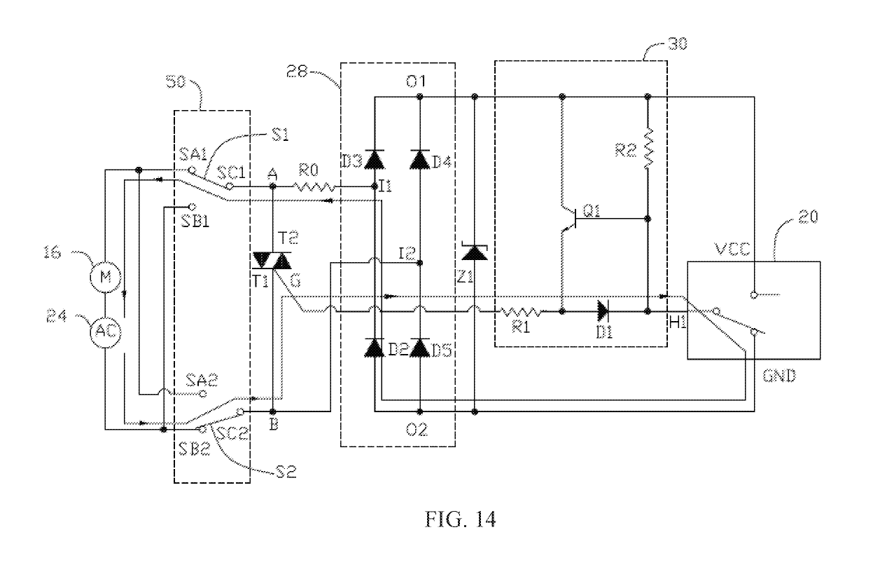

FIG. 11 shows a single-phase permanent-magnetic motor according to an embodiment of the present disclosure. The motor 10 includes a stator and a rotor 11 rotatable relative to the stator. The stator includes a stator core 12 and a stator winding 16 wound on the stator core 12. The stator core may be made of a soft magnetic material such as pure iron, cast iron, cast steel, electrical steel, silicon steel and ferrite. The rotor 11 is a permanent magnet rotor. The rotor 11 operates at a constant rotational speed of 60 f/p revs/min during a steady state in a case that the stator winding 16 is connected in series to an alternating current power supply 24 (see FIG. 12), where the f denotes a frequency of the alternating current power supply and the p denotes the number of pole pairs of the rotor. In the embodiment, the stator core 12 includes two poles 14 opposite to each other. Each of the poles 14 includes a pole arc 15. An outer surface of the rotor 11 is opposite to the pole arc 15 with a non-uniform air gap therebetween. Preferably, a substantially uniform air gap 13 is formed between the outside surface of the rotor 11 and the pole arc 15. The “substantially uniform air gap” in the present disclosure means that a uniform air gap is formed in most space between the stator and the rotor, and a non-uniformed air gap is formed only in a small part of the space between the stator and the rotor. Preferably, a concave starting groove 17 is disposed on the pole arc 15 of the pole of the stator, and parts of the pole arc 15 other than the starting groove 17 are concentric with the rotor. With the configuration described above, a non-uniform magnetic field may be formed, so that a polar axis S1 of the rotor has an angle of inclination relative to a central axis S2 of the pole of the stator when the rotor is at rest, thereby allowing the rotor 11 to have a starting torque in response to the motor driving circuit 18 every time the motor is powered. Specifically, the polar axis S1 of the rotor refers to a boundary between two magnetic poles having different polarities, and the central axis S2 of the pole 14 of the stator refers to a connection line passing through centers of the two poles 14 of the stator. In the embodiment, each of the stator and the rotor includes two magnetic poles. It can be understood that, in more embodiments, other types of non-uniform air gap may be formed between the outside surface of the rotor 11 and the pole arc 15, the number of magnetic poles of the stator may be not equal to the number of magnetic poles of the rotor, and the stator and the rotor may have more magnetic poles such as 4 or 6.

FIG. 12 is a schematic circuit diagram of a motor 10 according to a first embodiment of the present disclosure. The motor 10 is described with an example of single-phase permanent-magnetic synchronous motor. The stator winding 16 of the motor is connected to a motor driving circuit 18 in series across the alternating current power supply 24. The motor driving circuit 18 is capable of controlling the forward or reverse rotation of the motor. The alternating current power supply 24 may be the mains supply of 220 V, 230 V or the like, or may be alternating current power outputted by an inverter.

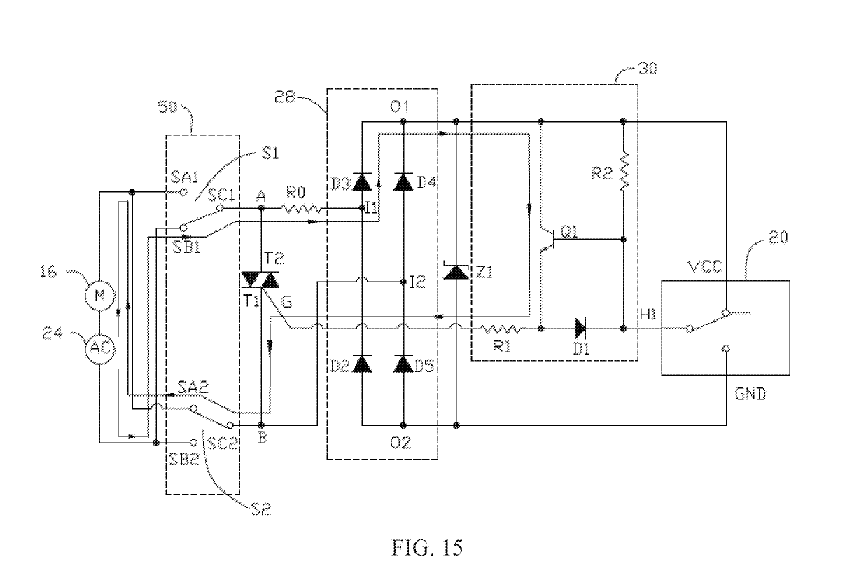

In the present embodiment, the motor driving circuit 18 includes a magnetic sensor integrated circuit 27, a rectifier 28, a controllable bidirectional alternating current switch 26 and a rotational direction control circuit 50. The magnetic sensor integrated circuit 27 includes a detecting circuit 20 and a switch control circuit 30 (see FIG. 13). The controllable bidirectional alternating current switch 26 is connected between a first node A and a second node B. The rectifier 28 is configured to generate a direct current voltage for at least the detecting circuit 20. The rectifier 28 is connected to the node A through a resistor R0. The resistor R0 is a voltage dropper. It can be understood that, in other embodiments, the dropping resistor may be not provided or may be provided in other appropriate positions. The rotational direction control circuit 50 connects the first node A and the second node B, and is configured to selectively connect the first node A to a first terminal of an external alternating current power supply 24 through a stator winding 16 and connect the second node B to a second terminal of the external alternating current power supply 24, or connect the first node A to the second terminal of the external alternating current power supply 24 and connect the second node B to the first terminal of the external alternating current power supply 24 through the stator winding, based on the rotational direction setting of the motor. The first terminal and the second terminal of the external alternating current power supply 24 may be a fire wire and a zero line respectively. The detecting circuit 20 is configured to detect a magnetic pole position of the rotor 11 and output a magnetic pole position signal from an output terminal of the detecting circuit. The switch control circuit 30 is configured to control the controllable bidirectional alternating current switch 26 to be turned on or be turned off in a predetermined way based on the magnetic pole position signal outputted by the detecting circuit 20 and based on a difference between a potential of the first node A and a potential of the second node B, so as to control the forward or reverse rotation of the motor.

Referring to FIG. 13, a circuit diagram of the motor driving circuit 18 shown in FIG. 12 according to a first embodiment is provided. The detecting circuit 20 is configured to detect a magnetic pole position of the rotor 11 of the motor. The detecting circuit 20 is preferably a switch-type Hall sensor. It should be noted that, FIG. 13 to FIG. 16 only illustrate working principles of the circuit in a case that an output terminal H1 of the detecting circuit 20 outputs a logic high level signal or a logic low level signal, which are for better understanding and are not intended to limit the specific connection among the terminals in the detecting circuit 20. The Hall sensor is arranged near to the rotor 11 of the motor when applying to the motor 10. The rectifier 28 includes four diodes D2 to D5. A cathode of the diode D2 is connected to an anode of the diode D3, a cathode of the diode D3 is connected to a cathode of the diode D4, an anode of the diode D4 is connected to a cathode of the diode D5, and an anode of the diode D5 is connected to an anode of the diode D2. The cathode of the diode D2 serves as a first input terminal I1 of the rectifier 28 and is connected to the first node A through a resistor R0. The resistor R0 may serve as a voltage dropper. The anode of the diode D4 serves as a second input terminal I2 of the rectifier 28 and is connected to the second node B. The cathode of the diode D3 serves as a first output terminal O1 of the rectifier 28 and is connected to the detecting circuit 20 and the switch control circuit 30. The first output terminal O1 outputs a high direct current operation voltage. The anode of the diode D5 serves as a second output terminal O2 of the rectifier 28 and is connected to the detecting circuit 20. The second output terminal O2 outputs a low voltage lower than the first output voltage. A zener diode Z1 is connected between the first output terminal O1 and the second output O2 of the rectifier 28, with an anode of the zener diode Z1 being connected to the second output terminal O2 and a cathode of the zener diode Z1 being connected to the first output terminal O1.

In the embodiment, the detecting circuit 20 includes a power supply terminal VCC, a ground terminal GND and an output terminal H1. The power supply terminal VCC is connected to the first output terminal O1 of the rectifier 28, the ground terminal GND is connected to the second output terminal O2 of the rectifier 28, and the output terminal H1 is connected to the switch control circuit 30. The output terminal H1 of the detecting circuit 20 outputs a magnetic pole position signal at a logic high level if the magnetic polarity of the rotor detected by the detecting circuit 20 is north and outputs a magnetic pole position signal at a logic low level if the magnetic polarity of the rotor detected by the detecting circuit 20 is south. In another embodiment, the output terminal H1 of the detecting circuit 20 outputs a magnetic pole position signal at a logic low level if the magnetic polarity of the rotor detected is north, and outputs a magnetic pole position signal at a logic high level if the magnetic polarity of the rotor detected is south.

The switch control circuit 30 includes a first terminal connected to the first output terminal O1 of the rectifier 28, a second terminal connected to the output terminal of the detecting circuit 20, and a third terminal connected to a control terminal of the controllable bidirectional alternating current switch 26. The switch control circuit 30 includes a resistor R2, a triode Q1, a diode D1 and a resistor R1. The diode D1 and the resistor R1 are connected in series between the output terminal H1 of the detecting circuit 20 and the control terminal of the controllable bidirectional alternating current switch 26. The triode Q1 is a NPN triode. A cathode of the diode D1 serves as the second terminal and is connected to the output terminal H1 of the detecting circuit 20. The resistor R2 has a terminal connected to the first output terminal O1 of the rectifier 28 and the other terminal connected to the output terminal H1 of the detecting circuit 20. The triode Q1 has a base connected to the output terminal H1 of the detecting circuit 20, an emitter connected to the anode of the diode D1 and a collector serving as the first terminal and connected to the first output terminal O1 of the rectifier 28. The terminal of the resistor R1 that is not connected to the diode D1 serves as the third terminal.

The controllable bidirectional alternating current switch 26 is preferably a triac. Two anodes T2 and T1 of the triac are connected to the first node A and the second node B respectively, and a control terminal G is connected to the third terminal of the switch control circuit 30. It can be understood that, the controllable bidirectional alternating current switch 26 may include an electronic switch, which is capable of allowing a current to flow in both directions, consisting of one or more of a metal-oxide semiconductor field effect transistor, a controllable silicon rectifier, a triac, an insulated gate bipolar transistor, a bipolar junction transistor, a semiconductor thyratron, and an optocoupler. For example, the controllable bidirectional alternating current switch may be formed by two metal-oxide semiconductor field effect transistors, or two controllable silicon rectifiers, or two insulated gate bipolar transistor, or bipolar junction transistors.

The switch control circuit 30 is configured to turn on the controllable bidirectional alternating current switch 26 in a case that the potential of the first node A is higher than the potential of the second node B and the second terminal of the switch control circuit receives a first signal, or in a case that the potential of the first node A is lower than the potential of the second node B and the second terminal of the switch control circuit receives a second signal, and to turn off the controllable bidirectional alternating current switch 26 in a case that the potential of the first node A is higher than the potential of the second node B and the second terminal of the switch control circuit receives the second signal, or in a case that the potential of the first node A is lower than the potential of the second node B and the second terminal of the switch control circuit receives the first signal. The first signal and the second signal are magnetic pole position signals outputted by the detecting circuit 20. In the embodiment, the first signal is a logic high level signal, and the second signal is a logic low level signal.

The rotational direction control circuit 50 includes a first switch S1 and a second switch S2. Each of the first switch S1 and the second switch S2 includes a first terminal, a second terminal and a third terminal. The first terminal SC1 of the first switch is connected to the first node A, the second terminal SA1 of the first switch S1 is connected to the first terminal of the external alternating current power supply 24 through the winding 16 of the motor, and the third terminal SB1 of the first switch S1 is connected to the second terminal of the external alternating current power supply 24. The first terminal SC2 of the second switch S2 is connected to the second node B, the second terminal SA2 of the second switch S2 is connected to the second terminal SA1 of the first switch S1, and the third terminal SB2 of the second switch S2 is connected to the second terminal of the external alternating current power supply.

The working principle of the motor driving circuit 18 is described in conjunction with FIG. 13 to FIG. 16.

According to the electromagnetic theory, a rotational direction of a rotor of a signal-phase permanent-magnetic motor may be changed by changing the power supply for the stator winding 16. If a polarity of the rotor detected by the detecting circuit 20 is N, and the rotational direction control circuit 50 controls the external alternating current power supply, of which a current flows through the stator winding 16, to operate in a positive half-cycle, the motor rotates forward (for example, clockwise (CW)). It can be understood that, if the polarity of the rotor detected by the detecting circuit 20 is still N, and the rotational direction control circuit 50 controls the external alternating current power supply, of which the current flows through the stator winding 16, to operate in a negative half-cycle, the motor rotates reversely (for example, counter-clockwise (CCW)). The embodiments of the present disclosure are designed in accordance with this principle, i.e., the forward or reverse rotation of the motor is controlled by adjusting a direction of a current flowing through the stator winding 16 based on the polarity of the rotor detected by the detecting circuit 20. It can be understood that, if the motor is required to rotate reversely, the motor is stopped first and then the rotational direction control circuit 50 changes the rotational direction of the motor.

An example that the motor rotates forward is described with reference to FIG. 13 and FIG. 14. Referring to FIG. 13, if the motor is required to rotate forward, the first terminal SC1 and the second terminal SA1 of the first switch S1 are connected to each other, and the first terminal SC2 and the third terminal SB2 of the second switch S2 are connected to each other. In the starting of the motor, if a voltage outputted by the alternating current power supply 24 is in the positive half-cycle, the potential of the first node A is higher than the potential of the second node B, and the magnetic pole position of the rotor detected by the detecting circuit 20 is N, the detecting circuit 20 outputs a magnetic pole position signal at a logic high level “1” to the switch control circuit 30. The diode D1 of the switch control circuit 30 is turned off and the triode Q1 of the switch control circuit 30 is turned on. A current flowing from the second terminal of the switch control circuit 30 drives the controllable bidirectional alternating current switch 26 to be turned on. In this procedure, a direction of a current flowing through the stator winding 16 is shown by the arrow in FIG. 13, i.e., a bottom-up direction through the stator winding 16, and the rotor 11 rotates clockwise.

Referring to FIG. 14, the first terminal SC1 and the second terminal SA1 of the first switch S1 are connected to each other, the first terminal SC2 and the third terminal SB2 of the second switch S2 are connected to each other, i.e., the first switch S1 and the second switch S2 are still configured to allow the motor to rotate forward. If a voltage outputted by the alternating current power supply 24 is in the negative half-cycle, the potential of the second node B is higher than the potential of the first node A, and the magnetic pole position of the rotor detected by the detecting circuit 20 is S, the detecting circuit 20 outputs a magnetic pole position signal at a logic low level “0”. The diode D1 of the switch control circuit 30 is turned on and the triode Q1 of the switch control circuit 30 is turned off. A current flows from the alternating current power supply in the negative half-cycle to the control terminal G of the controllable bidirectional alternating current switch 26, the resistor R1 and the diode D1 in a direction as shown in FIG. 14. The controllable bidirectional alternating current switch 26 is turned on. In this procedure, the direction of the current flowing through the stator winding 16 is shown by the arrow in FIG. 14, i.e., a top-down direction through the stator winding 16, and the rotor 11 rotates clockwise.

In a case that the first switch S1 and the second switch S2 are connected to allow the motor to rotate forward, the alternating current power supply is in the negative half-cycle and the magnetic pole position of the rotor is N, or the alternating current power supply is in the positive half-cycle and the magnetic pole position of the rotor is S, the switch control circuit 30 does not trigger the controllable bidirectional alternating current switch 26, no current flows through the stator winding 16, and the rotor 11 rotates with inertia. If the motor is in a standstill state, the rotor 11 does not rotate.

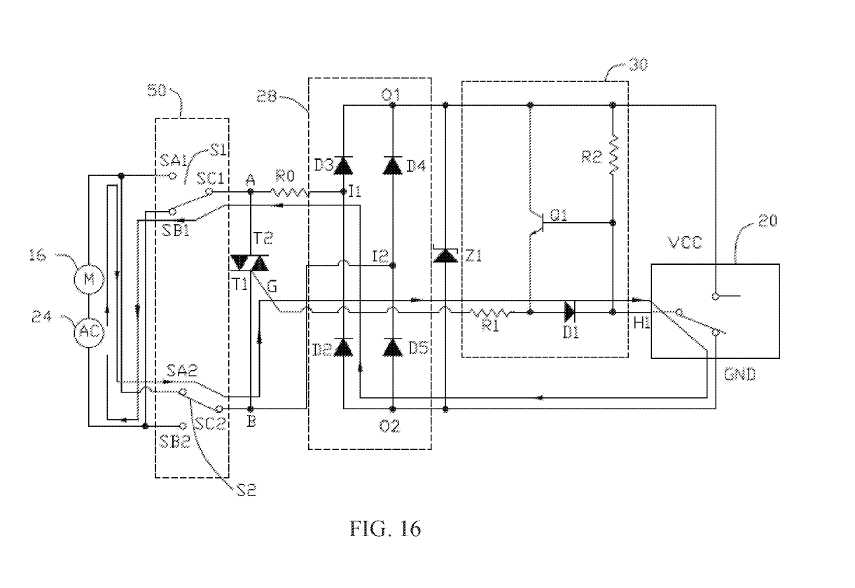

The situation that the motor rotates reversely is described with reference to FIG. 15 and FIG. 16. Referring to FIG. 15, if the motor is required to rotate reversely, states of the first switch S1 and the second switch S2 are changed such that the first terminal SC1 and the third terminal SB1 of the first switch S1 are connected to each other, and the first terminal SC2 and the second terminal SA2 of the second switch S2 are connected to each other. In the starting of the motor, if the alternating current power supply 24 is in the negative half-cycle, the potential of the first node A is higher than the potential of the second node B because of the changes of states of the switch S1 and the second S2. If the magnetic pole position of the rotor detected by the detecting circuit 20 is N, the detecting circuit 20 outputs a magnetic pole position signal at a logic high level “1” to the switch control circuit 30. The diode D1 of the switch control circuit 30 is turned off and the triode Q1 of the switch control circuit 30 is turned on. A current flowing from the second terminal of the switch control circuit 30 drives the controllable bidirectional alternating current switch 26 to be turned on. In this procedure, the direction of the current flowing through the stator winding 16 is shown by the arrow in FIG. 15, i.e., a top-down direction through the stator winding 16, which is reverse to the direction of the current flowing through the stator winding 16 when the magnetic pole position of the rotor is N as shown in FIG. 3, and the rotor 11 rotates counter-clockwise.

Referring to FIG. 16, if a voltage outputted by the alternating current power supply 24 is in the positive half-cycle, the potential of the second node B is higher than the potential of the first node A because of the changes of states of the first switch S1 and the second switch S2. If the magnetic pole position of the rotor detected by the detecting circuit 20 is S, the detecting circuit 20 outputs a magnetic pole position signal at a logic low level “0”. The diode D1 of the switch control circuit 30 is turned on and the triode Q1 of the switch control circuit 30 is turned off. A current flows from the alternating current power supply in the positive half-cycle to the control terminal G of the controllable bidirectional alternating current switch 26, the resistor R1 and the diode D1 in a direction as shown in FIG. 16. The controllable bidirectional alternating current switch 26 is turned on. In this procedure, the direction of the current flowing through the stator winding 16 is shown by the arrow in FIG. 16, i.e., a bottom-up direction through the stator winding 16, which is reverse to the direction of the current flowing through the stator winding 16 when the magnetic pole position of the rotor is S as shown in FIG. 14, and the rotor 11 rotates counter-clockwise.

In a case that the first switch S1 and the second switch S2 are connected to allow the motor to rotate reversely, the alternating current power supply is in the positive half-cycle and the magnetic pole position of the rotor is north, or the alternating current power supply is in the negative half-cycle and the magnetic pole position of the rotor is south, the switch control circuit 30 does not trigger the controllable bidirectional alternating current switch 26, no current flows through the stator winding 16, and the rotor 11 rotates with inertia. If the motor is in a standstill state, the rotor 11 does not rotate.

In summary, the rotational direction control circuit 50 selectively connects the first node A to the first terminal of the external alternating current power supply 24 through the winding 16 of the motor and connects the second node B to the second terminal of the external alternating current power supply 24, or connects the first node A to the second terminal of the external alternating current power supply 24 and connects the second node B to the first terminal of the external alternating current power supply 24 through the winding 16 of the motor, based on the rotational direction setting of the motor, so as to control the difference between the potential of the first node A and the potential of the second node B. The switch control circuit 30 turns on or turns off the controllable bidirectional alternating current switch based on the magnetic pole position signal and the difference between the potential of the first node A and the potential of the second node B, so as to control the direction of the current flowing through the stator winding 16, thereby controlling the rotational direction of the motor.

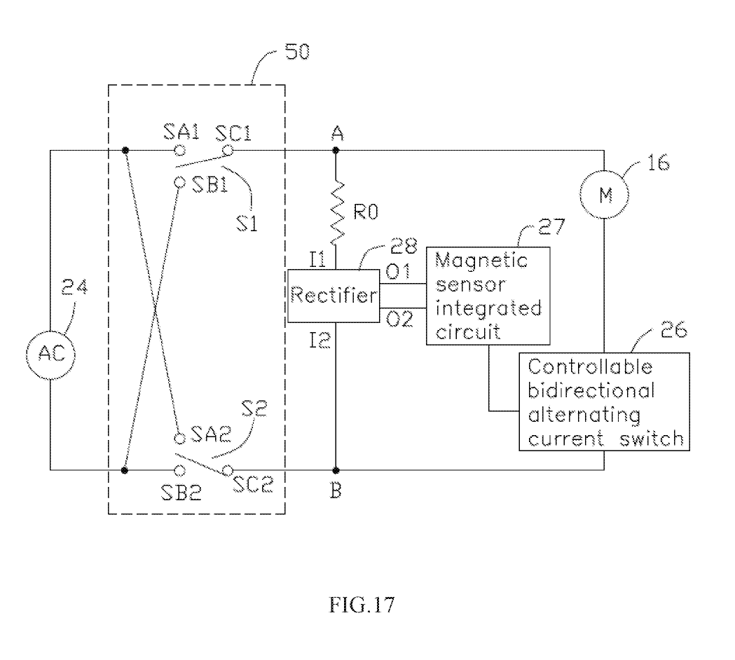

According to the principle in the present disclosure, the external alternating current power supply 24, the stator winding 16 and the motor driving circuit may be connected in other ways. Referring to FIG. 17, a schematic circuit diagram of a motor according to a second embodiment of the present disclosure is shown. The circuit shown in FIG. 17 differs from the circuit shown in FIG. 12 in that the stator winding 16 and the controllable bidirectional alternating current switch 26 are connected in series between the first node A and the second node B, the first terminal of the external alternating current power supply 24 is connected to the second terminal SA1 of the first switch S1, and the second terminal of the external alternating current power supply 24 is connected to the third terminal SB2 of the second switch S2.

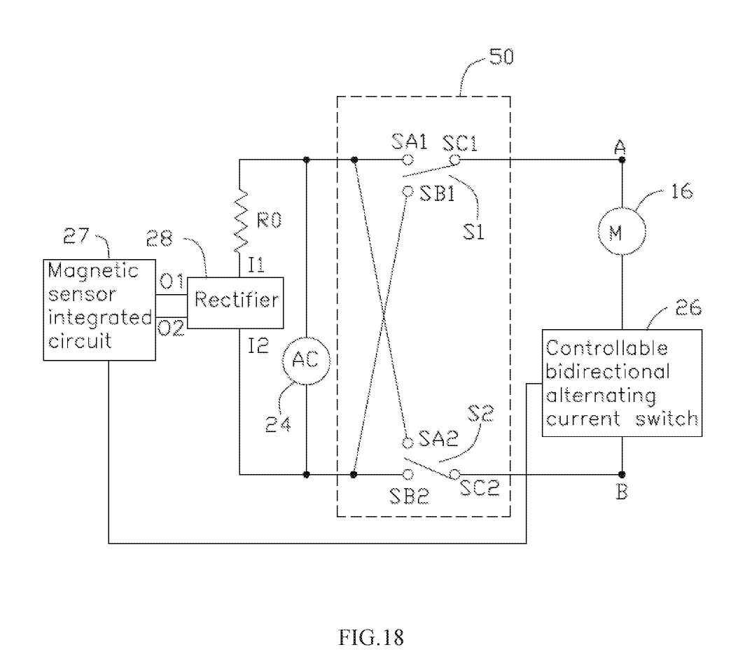

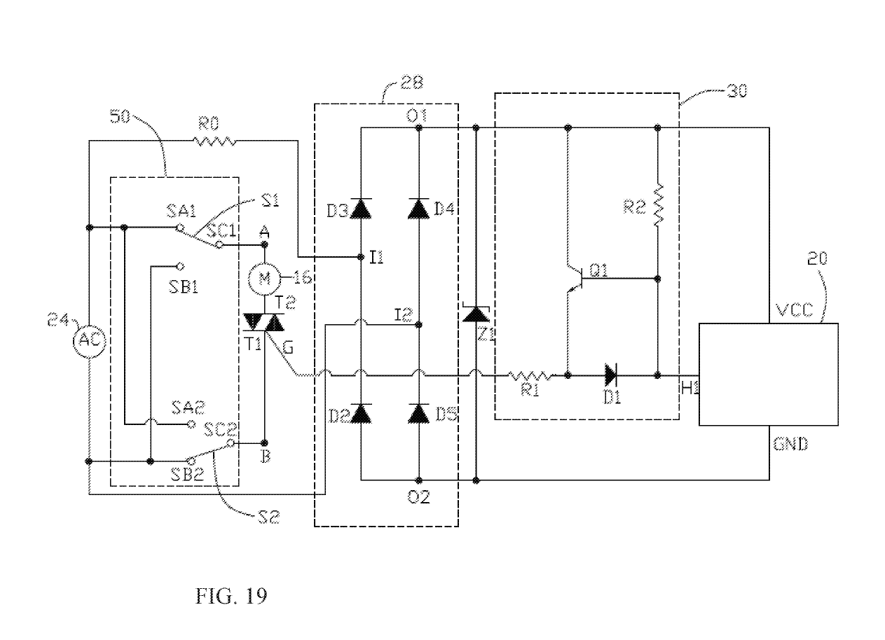

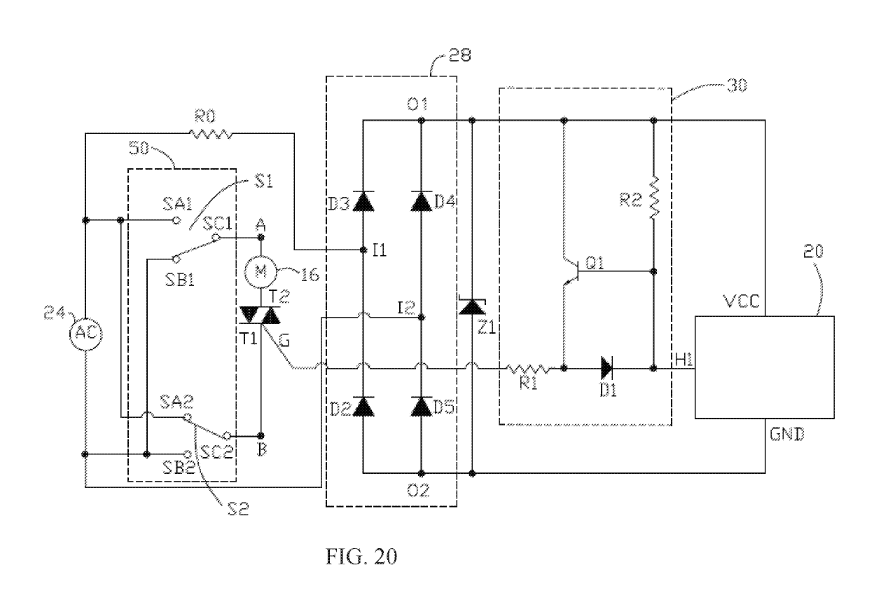

Referring to FIG. 18, a schematic circuit diagram of a motor according to a third embodiment of the present disclosure. The circuit shown in FIG. 18 differs from the circuit shown in FIG. 12 in that the stator winding 16 and the controllable bidirectional alternating current switch 26 are connected in series between the first node A and the second node B, the first terminal of the external alternating current power supply 24 is connected to the second terminal SA1 of the first switch S1, the second terminal of the external alternating current power supply 24 is connected to the third terminal SB2 of the second switch S2, the rectifier 28 is connected to the first terminal of the external alternating current power supply 24 through the resistor R0, and the second terminal of the external alternating current power supply 24 is connected to the second input terminal I2 of the rectifier 28. The circuit shown in FIG. 18 differs from the circuit shown in FIG. 17 as follows: In FIG. 17, the first input terminal of the rectifier 28 is connected to the first terminal SC1 of the first switch S1 through the resistor R0, and the second input terminal of the rectifier is connected to the first terminal SC2 of the second switch, while in FIG. 18, the first terminal of the external alternating current power supply 24 is connected to the first input terminal I1 of the rectifier 28 through the resistor R0, and the second terminal of the external alternating current power supply 24 is connected to the second input terminal I2 of the rectifier 28. An exemplary circuit diagram of the motor driving circuit according to a third embodiment is shown in FIG. 19 and FIG. 20.

FIG. 19 is a circuit diagram of the motor driving circuit as shown in FIG. 18 in a case that the rotor rotates forward. The first input terminal I1 of the rectifier 28 is connected to the first terminal of the external alternating current power supply 24 through the resistor R0, and the second input terminal I2 of the rectifier 28 is connected to the second terminal of the external alternating current power supply 24. In a case that the motor rotates forward, the first terminal SC1 and the second terminal SA1 of the first switch S1 are connected to each other, and the first terminal SC2 and the third terminal SB2 of the second switch S2 are connected to each other. In a case that the first switch S1 and the second switch S2 are configured such that that the motor rotates forward, the procedure of controlling the motor to rotate forward is substantially the same as that of the embodiments shown in FIG. 3 and FIG. 4, which is not repeated herein.

FIG. 20 is a circuit diagram of the motor driving circuit as shown in FIG. 18 in a case that the rotor rotates forward. In a case that the motor rotates reversely, the first terminal SC1 and the third terminal SB1 of the first switch S1 are connected to each other, and the first terminal SC2 and the second terminal SA2 of the second switch S2 are connected to each other. In the case that the first switch S1 and the second switch S2 are configured such that that the motor rotates reversely, the procedure of controlling the motor to rotates reversely is substantially the same as that of the embodiments shown in FIG. 15 and FIG. 16, which is not repeated herein.

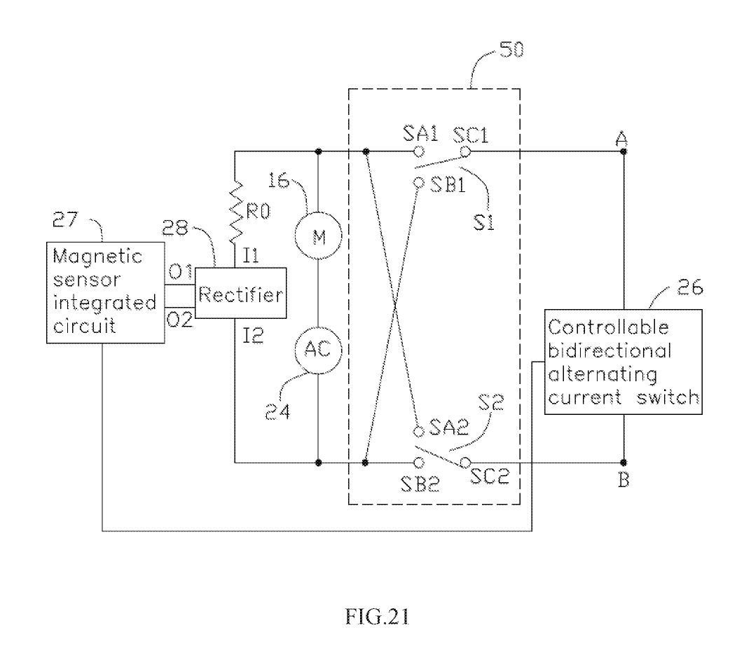

Referring to FIG. 21, a schematic circuit diagram of a motor according to a fourth embodiment of the present disclosure is shown. The circuit shown in FIG. 21 differs from the circuit shown in FIG. 18 in that the controllable bidirectional alternating current switch 26 is connected between the first node A and the second node B, the first terminal of the external alternating current power supply 24 is connected to the second terminal SA1 of the first switch S1 through the stator winding 16, and the second terminal of the external alternating current power supply 24 is connected to the third terminal SB2 of the second switch S2. The circuit shown in FIG. 21 differs from the circuit shown in FIG. 12 as follows: In FIG. 12, the first input terminal of the rectifier 28 is connected to the first terminal SC1 of the first switch S1 through the resistor R0, and the second input terminal of the rectifier is connected to the first terminal SC2 of the second switch, while in FIG. 21, the first input terminal I1 of the rectifier 28 is connected to the second terminal SC1/third terminal SB1 of the first switch S1 through the resistor R0, and the second input terminal I2 of the rectifier 28 is connected to the third terminal SB2/second terminal SA2 of the second switch.

In the above embodiments, each of the first switch S1 and the second switch S2 may be a mechanical switch or an electronic switch. The mechanical switch includes a relay, a single-pole double throw switch, and a single-pole single throw switch. The electronic switch includes a solid-state relay, a metal-oxide semiconductor field effect transistor, a controllable silicon rectifier, a triac, an insulated gate bipolar transistor, a bipolar junction transistor, a semiconductor thyratron, an optocoupler, and the like.

The motor driving circuit according to the embodiments of the present disclosure controls, based on the magnetic pole position of the rotor 11, the direction of the current flowing through the stator winding of the motor, via the rotational direction control circuit 50, so as to control the forward or reverse rotation of the motor. If a driving motor for an application having a reverse rotational direction is required, only the states of the terminals of the first switch S1 and the second switch S2 needs to be changed, without any other change to the driving circuit. The motor driving circuit has a simple structure and a high versatility.

It can be understood by those skilled in the art that, the motor according to the embodiments of the present disclosure is applicable to drive a device such as a vehicle window, an office rolling blind or a home rolling blind, a pump or a fan, for home appliance. The motor according to the embodiments of the present disclosure may include a permanent-magnetic alternating current motor, such as a permanent-magnetic synchronous motor and a permanent-magnetic brushless direct current (BLDC) motor. Preferably, the motor according to the embodiments of the present disclosure is a single-phase permanent-magnetic alternating current motor, such as a single-phase permanent-magnetic synchronous motor and a single-phase permanent-magnetic BLDC motor. In a case that the motor is a permanent-magnetic synchronous motor, the external alternating current power supply is the mains power supply. In a case that the motor is a permanent-magnetic BLDC motor, the external alternating current power supply may be an alternating current power supply outputted by an inverter.

It can be understood by those skilled in the art that, the motor driving circuit may be integrated and packaged into an integrated circuit, so as to reduce the cost of the circuit and improve the reliability thereof. The integrated circuit includes a housing, several pins extending out of the housing, and a motor driving circuit arranged on a semiconductor substrate. The semiconductor substrate and the motor driving circuit are packaged in the housing.

In another embodiment, all of or a part of the rectifier 28, the detecting circuit 20, the rotational direction control circuit 50 and the switch control circuit 30 may be integrated into an integrated circuit depending on practical conditions. For example, only the rotational direction control circuit 50, the detecting circuit 20 and the switch control circuit 30 are integrated into an integrated circuit, while the rectifier 28, the controllable bidirectional alternating current switch 26 and the resistor R0 are arranged outside the integrated circuit.

In another embodiment, each of the components of the motor driving circuit may be arranged discretely on a printed circuit board in accordance with a design requirement.

The above embodiments are only preferred embodiments of the present disclosure and are not intended to limit the present disclosure. Any change, equivalent substitution, improvement, or the like, within the spirit and principles of the present disclosure all fall within the scope of protection of the present disclosure.

1. A motor driving circuit, configured to drive a rotor of a motor to rotate relative to a stator of the motor, wherein the motor driving circuit comprises:
a controllable bidirectional alternating current switch connected between a first node and a second node;
a rotational direction control circuit connected to the first node and the second node and configured to selectively connect the first node to a first terminal of an external alternating current power supply through a winding of the motor and connect the second node to a second terminal of the external alternating current power supply, or to connect the first node to the second terminal of the external alternating current power supply and connect the second node to the first terminal of the external alternating current power supply through the winding of the motor;
a detecting circuit configured to detect a magnetic pole position of the rotor and output a magnetic pole position signal from an output terminal; and
a switch control circuit configured to control the controllable bidirectional alternating current switch to be turned on or be turned off in a predetermined way, based on the magnetic pole position signal outputted by the detecting circuit and a difference between a potential of the first node and a potential of the second node.

2. The motor driving circuit according to claim 1, wherein the switch control circuit is configured to turn on the controllable bidirectional alternating current switch in a case that the potential of the first node is higher than the potential of the second node and the detecting circuit outputs a first magnetic pole position signal, or in a case that the potential of the first node is lower than the potential of the second node and the detecting circuit outputs a second magnetic pole position signal and configured to turn off the controllable bidirectional alternating current switch in a case that the potential of the first node is higher than the potential of the second node and the detecting circuit outputs the second magnetic pole position signal, or in a case that the potential of the first node is lower than the potential of the second node and the detecting circuit outputs the first magnetic pole position signal.

3. The motor driving circuit according to claim 2, wherein the rotor rotates in a first direction when the rotational direction control circuit connects the first node to the first terminal of the external alternating current power supply through the winding of the motor and connects the second node to the second terminal of the external alternating current power supply; and the rotor rotates reversely in a second direction when the rotational direction control circuit connects the first node to the second terminal of the external alternating current power supply and connects the second node to the first terminal of the external alternating current power supply through the winding of the motor.

4. The motor driving circuit according to claim 3, wherein the rotational direction control circuit comprises a first switch and a second switch, each of the first switch and the second switch comprises a first terminal, a second terminal and a third terminal, the first terminal of the first switch is connected to the first node, the second terminal of the first switch is connected to the first terminal of the external alternating current power supply through the winding of the motor, and the third terminal of the first switch is connected to the second terminal of the external alternating current power supply; the first terminal of the second switch is connected to the second node, the second terminal of the second switch is connected to the second terminal of the first switch, and the third terminal of the second switch is connected to the second terminal of the external alternating current power supply; in a case that the motor rotates in the first direction, the first terminal of the first switch is connected to the second terminal of the first switch, and the first terminal of the second switch is connected to the third terminal of the second switch; and in a case that the motor rotates reversely in the second direction, the first terminal of the first switch is connected to the third terminal of the first switch, and the first terminal of the second switch is connected to the second terminal of the second switch.

5. The motor driving circuit according to claim 1, wherein the motor driving circuit further comprises a rectifier configured to at least supply a direct current voltage to the detecting circuit.

6. The motor driving circuit according to claim 5, wherein the rectifier is connected to the first node through a voltage dropper; or the rectifier is connected to the first terminal of the external alternating current power supply through a voltage dropper and the winding of the motor.

7. The motor driving circuit according to claim 6, wherein at least two or all of the rectifier, the detecting circuit, the switch control circuit and the rotational direction control circuit are integrated into an integrated circuit.

8. The motor driving circuit according to claim 1, wherein at least two or all of the detecting circuit, the switch control circuit and the rotational direction control circuit are integrated into an integrated circuit.

9. A motor driving circuit, configured to drive a rotor of a motor to rotate relative to a stator of the motor, wherein the motor driving circuit comprises:
a controllable bidirectional alternating current switch connected to a winding of the motor in series between a first node and a second node;
a rotational direction control circuit connected to the first node and the second node and configured to selectively connect the first node to a first terminal of an external alternating current power supply and connect the second node to a second terminal of the external alternating current power supply, or connect the first node to the second terminal of the external alternating current power supply and connect the second node to the first terminal of the external alternating current power supply;
a detecting circuit configured to detect a magnetic pole position of the rotor and output a magnetic pole position signal from an output terminal; and
a switch control circuit configured to control the controllable bidirectional alternating current switch to be turned on or be turned off in a predetermined way, based on the magnetic pole position signal outputted by the detecting circuit, a potential of the first node and a potential of the second node.

10. The motor driving circuit according to claim 9, wherein the motor driving circuit further comprises a rectifier configured to at least supply a direct current voltage to the detecting circuit, and the rectifier is connected to the first node through a voltage dropper or connected to the first terminal of the external alternating current power supply through a voltage dropper and the winding of the motor.

11. The motor driving circuit according to claim 9, wherein the switch control circuit is configured to turn on the controllable bidirectional alternating current switch in a case that the potential of the first node is higher than the potential of the second node and the detecting circuit outputs a first magnetic pole position signal, or in a case that the potential of the first node is lower than the potential of the second node and the detecting circuit outputs a second magnetic pole position signal and configured to turn off the controllable bidirectional alternating current switch in a case that the potential of the first node is higher than the potential of the second node and the detecting circuit outputs the second magnetic pole position signal, or in a case that the potential of the first node is lower than the potential of the second node and the detecting circuit outputs the first magnetic pole position signal.

12. The motor driving circuit according to claim 9, wherein the rotor rotates in a first direction in a case that the rotational direction control circuit connects the first node to the first terminal of the external alternating current power supply through the winding of the motor and connects the second node to the second terminal of the external alternating current power supply; and the rotor rotates reversely in a second direction in a case that the rotational direction control circuit connects the first node to the second terminal of the external alternating current power supply and connects the second node to the first terminal of the external alternating current power supply through the winding of the motor.

13. The motor driving circuit according to claim 12, wherein the rotational direction control circuit comprises a first switch and a second switch, each of the first switch and the second switch comprises a first terminal, a second terminal and a third terminal, the first terminal of the first switch is connected to the first node, the second terminal of the first switch is connected to the first terminal of the external alternating current power supply through the winding of the motor, and the third terminal of the first switch is connected to the second terminal of the external alternating current power supply; the first terminal of the second switch is connected to the second node, the second terminal of the second switch is connected to the second terminal of the first switch, and the third terminal of the second switch is connected to the second terminal of the external alternating current power supply; in a case that the motor rotates in the first direction, the first terminal of the first switch is connected to the second terminal of the first switch, and the first terminal of the second switch is connected to the third terminal of the second switch, and in a case that the rotor rotates reversely in the second direction, the first terminal of the first switch is connected to the third terminal of the first switch, and the first terminal of the second switch is connected to the second terminal of the second switch.

14. An application device having a motor which includes a stator, a rotor and the motor driving circuit according to claim 1.

15. The application device according to claim 14, wherein the motor is a single-phase permanent-magnetic alternating current motor.

16. An application device having a motor which includes a stator, a rotor and the motor driving circuit according to claim 9.

17. The application device according to claim 16, wherein the motor is a single-phase permanent-magnetic synchronous motor or a single-phase permanent-magnetic brushless direct current (BLDC) motor.
